(19) United States
(12) Patent Application Publication
(10) Pub. No.: US 2025/0033310 A1
(43) Pub. Date: Jan. 30, 2025

(54) POWDER PRESS HAVING A HYDRAULIC PRESS DRIVE

(71) Applicant: DORST TECHNOLOGIES GMBH & CO. KG, Kochel am See (DE)

(72) Inventors: Maximilian HÄLTERLEIN, Wielenbach (DE); Martin ROSSI, Mittenwald (DE)

(21) Appl. No.: 18/684,620

(22) PCT Filed: Aug. 18, 2022
(86) PCT No.: PCT/EP2022/073065

§ 371 Date: Oct. 18, 2024

(30) Foreign Application Priority Data
Aug. 18, 2021 (DE) 10 2021 121 461.0

(51) Int. Cl. B30B 15/16; B30B 1/32

(52) U.S. Cl. CPC B30B 15/161; B30B 1/32

(57) ABSTRACT

The invention relates to a hydraulic drive device (11) with at least one press cylinder, in particular a press synchronous cylinder, for a hydraulic press, preferably a powder press (10), wherein the hydraulic drive device is configured to guide a cylinder piston of the press cylinder in a rapid movement at increased speed towards a pressed part and to press the pressed part in a pressing movement at low speed, wherein the drive device comprises a switching valve (17), a controllable pressing movement pump (15), in particular a speed-controllable pressing movement pump (15) for conveying fluid for the pressing movement and a control unit (28) for controlling the pressing movement pump (15), wherein the drive device is configured to perform the rapid movement when the switching valve (17) is open and to perform the pressing movement when the switching valve (17) is closed, wherein the control unit (28) is configured to control the pressing movement pump (15) in such a way that a conveyance rate of the pressing movement pump (15) is already increased before the closing of the switching valve (17).

The invention relates to a hydraulic drive device with a press cylinder for a hydraulic press, preferably a powder press, as well as a corresponding powder press and a corresponding method for pressing a pressed part, in particular for powder pressing a powder pressed part.

The central component of hydraulic presses are press cylinders, which fulfil various functions. On the one hand, such press cylinders are used for opening and closing of a pressing tool of the hydraulic press at a high speed (rapid movement). On the other hand, via such press cylinders a high force in the closing direction (at low speed) is build up. The high closing forces required for pressing require a correspondingly large piston area to generate a maximum pressing force at a predetermined maximum pressure. With a large piston area correspondingly high volume flows result, so that comparatively largely build or dimensioned pumps and valves are required in the state of the art. To avoid oversized hydraulic drive and control elements, the rapid movement and press functions are separated in the state of the art. This means that cylinder units with a large area for the closing force as well as a small area for the comparatively fast and “powerless” opening and closing movements are used. Such press cylinders can be equipped with an integrated or separated rapid movement cylinder. In certain solutions, locking cylinder pistons are pulled along during the rapid movement action. The supply of hydraulic fluid (oil supply) can be fed separately from a container (“suction operation”). Alternatively, piston and annular chamber can be connected cyclically by means of a hydraulic switching valve (“flushing”).

Such solutions are comparatively complex in terms of both the manufacturing effort (especially the cylinder design) as well as the control engineering effort (especially with regard to the hydraulic control) and are therefore associated with high costs.

A further problem is that switching valves (e.g. for the connection of cylinder chambers of the same cylinder) can lead to undesired (short-term) and essentially uncontrolled movements of the press cylinder when switching over. In this context, DE 10 2018 222 425 A1 proposes a hydrostatic drive, in particular for a press or injection moulding machine or the like, which comprises a valve arrangement with several passive valves. By this a controlled transition from a rapid movement or pressing movement shall be enabled and thus the process sequence be improved. However, the solution according to DE 10 2018 222 425 A1 is considered to be comparatively complex.

It is therefore the object of the invention to propose a hydraulic drive device, a hydraulic press as well as a method for pressing a pressed part, whereby an uncontrolled movement of a press cylinder should be prevented or at least reduced as far as possible with comparatively little design effort.

This object is solved in particular by the features of claim 1.

In particular, the object is solved by a hydraulic drive device with at least one press cylinder (in particular a press synchronous cylinder) for a hydraulic press, preferably a powder press (in particular a metal powder and/or ceramic powder press), wherein the hydraulic drive device is configured to guide a cylinder piston of a press cylinder in a rapid movement at increased speed towards a pressed part and to press the pressed part in a pressing movement at low speed, wherein the drive device comprises a switching valve, a (controllable, in particular speed-controllable) pressing movement pump for conveying fluid for the pressing movement (into a corresponding chamber of the press cylinder) and a control unit (in particular an electronic control unit, preferably comprising at least one processor and/or an electronic memory) for controlling the pressing movement pump, wherein the drive device is configured to perform the rapid movement when the switching valve is open and to perform the pressing movement when the switching valve is closed (whereby for this the switching valve is preferably arranged into a corresponding connection or connecting line between two chambers of the press cylinder), wherein the control unit is configured to control the pressing movement pump in such a way that a conveyance rate (and/or speed) of the pressing movement pump is (already) increased before the closing of the switching valve.

One idea of the invention is to increase a conveyance rate of the pressing movement pump already before the switching valve is closed or before the actual initiation of the pressing movement (or to start with a corresponding conveyance of fluid). A conveying (or an increase in conveying) by the pressing movement pump is deliberately started at a point in time at which the fluid can actually still flow via the (open) switching valve and it would therefore not be necessary in principle to enable (additional or exclusive) conveying of the fluid by operating the pressing movement pump. However, it has been recognised that by a corresponding starting of the pressing movement pump (or increasing the conveyance rate of the pressing movement pump) upon an initiation of the pressing movement, less (or no) fluid flows through the switching valve, which is still open shortly before the switching over (or closing), so that even the closing process as such cannot lead to any (larger) uncontrolled movements. Overall, it is made possible in a simple manner to enable an initiation of the pressing movement without uncontrolled movements (or at least with a reduction in uncontrolled movements). The design effort for this is comparatively low.

In embodiments, the pressing movement pump does not convey any fluid during the rapid movement (in phases, in particular over at least 30% or at least 60% of the duration of the rapid movement) (but in particular only in an end phase of the time segment of the rapid movement, wherein the end phase can then account for at most 40% or at most 70% and/or at least 5% or at least 20% of the duration of the rapid movement).

As an increase is to be understood, in particular, that the conveyance rate of the pressing movement pump is brought from 0 to a value >0 (in particular continuously). However, it cannot be ruled out that the pressing movement pump already has a conveyance rate of >0 beforehand (i.e. before the increase).

As a conveyance rate is to be understood, in particular, a volume flow that is transported through the pump (i.e. in particular a volume of the fluid per time interval through the pump). In the case of a speed-controlled pressing movement pump, in particular the speed of the pump can be increased for this purpose.

Preferably, the conveyance rate of the pressing movement pump is increased to at least 50%, further preferably to at least 80%, even more preferably to (at least approximately) 100% of a maximum conveyance rate (during the pressing movement) and/or an conveyance rate present during an initial phase of the pressing movement already before the switching valve is closed (during the rapid movement or in an end portion or the above end phase of the time period which is determined by the rapid movement). In particular, if the conveyance rate during or shortly before the switching over of the switching valve corresponds to the conveyance rate that is also present during an initial phase of the pressing movement, negative impairments caused by the switching over process itself can be at least substantially prevented.

In embodiments, the conveyance rate of the pressing movement pump is increased continuously, in particular in the form of a ramp, already before the closing of the switching valve. Particularly preferably a ramp is realised, which is driven from a conveyance rate of 0 to 100% of the conveyance rate that is realised by the pressing movement pump during the switching over of the switching valve (or at the start of the pressing movement). The gradient of the ramp can, for example, be linear (at least in sections, possibly completely).

In embodiments, the (continuous) increase can extend over a time segment that comprises at least 5%, possibly at least 10% or at least 20% and/or at most 90% or at most 50% of the entire time segment (during which the rapid movement is run through).

A controlled transition to the pressing movement can be realised in a simple manner by means of a continuous increase.

Switching valve and pressing movement pump are connected in parallel to each other, in terms of fluid technology, according to the embodiment. Switching valve and/or pressing movement pump are preferably located, in terms of fluid technology, between two piston chambers of the press cylinder (or in a corresponding connection connecting these piston chambers). Specifically, the two piston chambers of the press cylinder can be connected by a connecting line, which initially starts from one piston chamber, then branches out (whereby the switching valve is arranged in one branch and the pressing movement pump in the other branch), then reunites and opens into the other piston chamber. Such a branching can also be omitted, for example, if switching valve and pressurisation pump be arranged in separate connecting lines, in terms of fluid technology, that connect the two cylinder chambers.

The hydraulic drive device preferably comprises at least one rapid movement cylinder (for example at least or exactly one or at least or exactly two rapid movement cylinders), in particular rapid movement synchronous cylinders (for example at least or exactly one or at least or exactly two rapid movement synchronous cylinders), for carrying out the rapid movement. Preferably, the fluid in a piston chamber of the rapid movement cylinder can be conveyed by at least one rapid movement pump.

Rapid movement cylinder and press cylinder can preferably be flowed-through by separate fluids or fluid flows. By this it is in particular to be understood that during a cycle of the hydraulic drive device or a pressing cycle, the same fluid particle cannot (at least theoretically) enter both the rapid movement cylinder as well as the press cylinder. It is therefore structurally prevented that at any time a fluid particle that was in the press cylinder at the previous point in time enters the rapid movement cylinder at a later point in time (apart from unintentional leaks). Different piston rods can be assigned to at least one rapid movement cylinder and at least one press cylinder. Alternatively (or additionally, for example if several rapid movement cylinders and/or several press cylinders are provided), the same piston rod can be assigned to the (respective) rapid movement cylinder and the (respective) press cylinder.

In specific embodiments, (exactly) one press cylinder and exactly one or exactly two rapid movement cylinders may be provided, wherein the rapid movement cylinders have their own piston rods (which are not simultaneously assigned to the press cylinder).

In further embodiments, (exactly) one rapid movement cylinder and (exactly) one press cylinder may be provided, wherein the same piston rod is assigned to the two cylinders.

The control unit preferably has at least one processor, at least one (electronic) memory and at least one input and/or output unit. The control unit can be integrated into a control unit for controlling the pressing process or be designed separately to such a control unit or be at least partially integrated into such a control unit.

The above object is furthermore solved in particular by a hydraulic press, preferably a powder press, comprising a hydraulic drive device according to one of the preceding claims.

The above object is furthermore solved in particular by a method for pressing a pressed part, in particular for powder pressing a powder pressed part (particularly preferably metal powder and/or ceramic powder pressed part), preferably using the above hydraulic drive device (i.e, wherein the above hydraulic drive device is used) and/or using the above press, in particular powder press (i.e, wherein the above powder press is used), wherein a cylinder piston of a press cylinder is guided in a rapid movement at increased speed towards a pressed part and the pressed part is pressed in a pressing movement at low speed, wherein a switching valve is open (or is opened) during the rapid movement and is closed (or is closed) during the pressing movement, wherein a conveyance rate of a pressing movement pump is already increased before the closing of the switching valve.

Preferably, a conveyance rate of the pressing movement pump is increased already before the closing of the switching valve to at least 50%, further preferably to at least 80%, still further preferably to (at least approximately) 100% of a maximum conveyance rate during the pressing movement and/or during a conveyance rate present in the initial phase of the pressing movement. In embodiments, the conveyance rate of the pressing movement pump can be increased continuously, in particular in the form of a ramp, already before the closing of the switching valve. Further method features result from the above description of the hydraulic drive device, whereby corresponding functional features can be implemented as specific method steps.

In particular, the method for pressing a pressed part comprises the actual pressing step (or the moulding of the pressed part).

Preferably, the powder press is designed for a (maximum) pressing force of at least 1000 kN, preferably at least 500 kN, or the above method is carried out at a pressing force of at least 1000 kN, in particular at least 500 kN.

The above-mentioned object is furthermore solved in particular by the use of a hydraulic drive device of the type described above or a press of the type described above for pressing a pressed part, in particular for powder pressing a powder pressed part.

Insofar as a rapid movement is mentioned above and/or below (without further specification), this is to be understood in particular as a forward rapid movement (i.e. a process in which the press plunger is moved in the direction of the pressed part). Accordingly, a “reverse rapid movement” should mean the reverse process, in which the press plunger is moved away from the pressed parts (or is moved away from the cavity).

The method for pressing can include a (forward) rapid movement, a pressing process as well as a reverse rapid movement. Between a forward rapid movement and the (main) pressing process, a pre-pressing can take place, in which, for example, a rapid movement pump continues to be operated (possibly at a reduced speed compared to the actual rapid movement). The phase of increasing the conveyance rate of the pump (before the switching over of the switching valve) can overlap at least with such a pre-pressing. The speed of the pressing movement pump can remain constant during the actual pressing movement, at least in sections, and may then decrease in an end phase of the pressing movement.

The actual pressing movement can be followed by a waiting period (with reduced speed of the pressing movement pump and possibly a non-conveying rapid movement pump). Furthermore, the pressing process can be followed (possibly subsequent to the waiting period) by a force reduction phase (in which, for example, a speed of the pressing movement pump changes sign and the rapid movement pump continues to not convey). Furthermore, the pressing process can be followed (still before the reverse rapid movement) by a loading phase and an uncovering phase. The reverse rapid movement can, again, be followed by a waiting period before the next forward rapid movement is initiated.

Preferably, the hydraulic drive device is used for an upper piston drive of a powder press (in particular a metal powder press). Accordingly, the above press preferably comprises a hydraulic drive device as the upper piston drive.

The pressing movement pump and/or the rapid movement pump is preferably a servo pump or 4-quadrant pump.

In embodiments, the press cylinder and input cylinder are driven by separate axles (alternatively and additionally, however, it is also possible to drive at least one press cylinder and at least one rapid movement cylinder via the same axle).

A (maximum) conveyance rate of the pressing movement pump can preferably be at least 1.5 times or at least 2 times or at least 2.5 times as large as a (maximum) conveyance rate of the rapid movement pump.

A piston area of the pressing movement cylinder is preferably at least 2 times or at least 4 times or at least 6 times and/or at most 20 times or at most 10 times as large as a piston area of the (one) rapid movement cylinder or of the several rapid movement cylinders in total (if several rapid movement cylinders are present).

An initiation of the pressing movement or a start of the same is preferably defined by a switching over of the switching valve.

In general, a discontinuity in the power transmission can be reduced or completely prevented by a switching over process of the switching valve.

Further embodiments result from the dependent claims.

The invention is described below with reference to embodiment examples, which are explained in more detail with reference to the drawings. Hereby show.

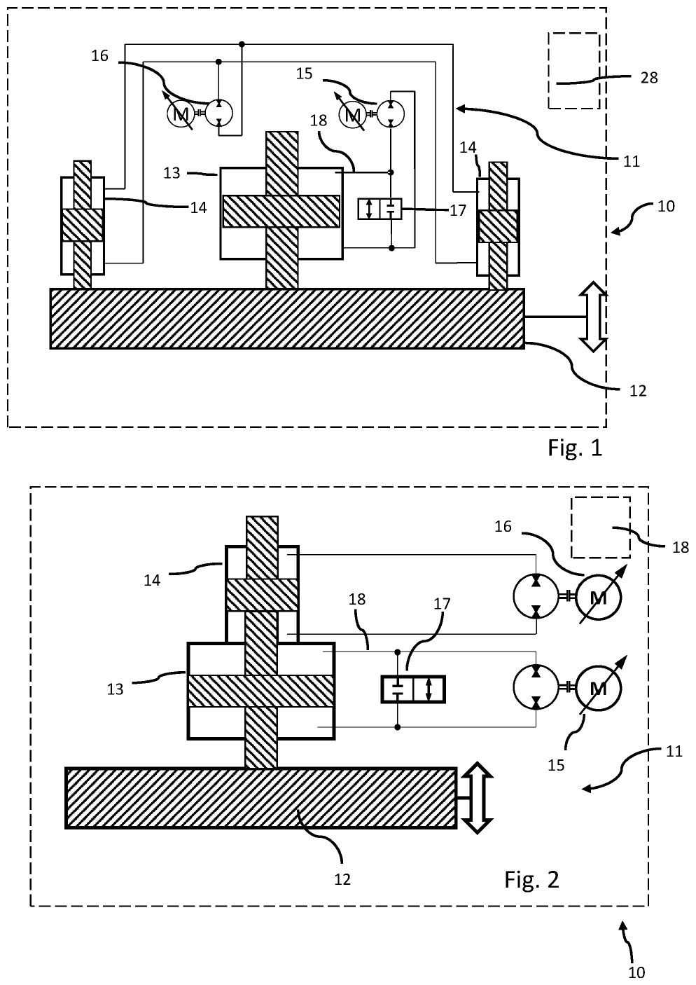

FIG. 1 a schematic representation of a first embodiment of the hydraulic drive device;

FIG. 2 an alternative embodiment of a hydraulic drive device; and

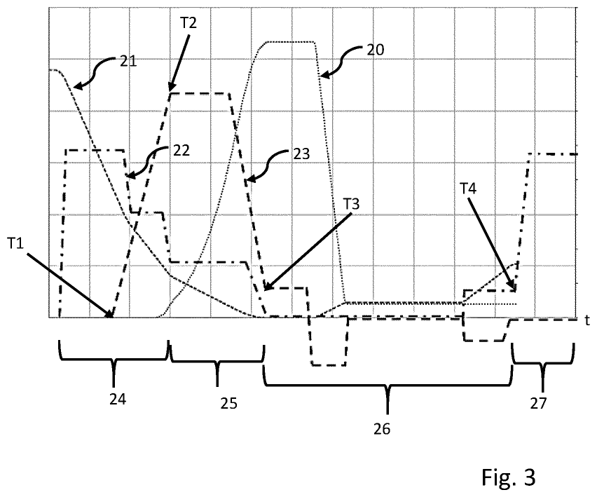

FIG. 3 a pressing cycle according to the invention.

In the following description, the same reference numerals are used for identical and identically acting parts.

FIG. 1 shows in a schematic representation a powder press 10, comprising a hydraulic drive device 11 as well as a press crosshead 12. The hydraulic drive device 11 comprises a pressing movement cylinder 13 as well as two (separate) rapid movement cylinders 14 (only one or more than two rapid movement cylinders 14 can also be provided). Pressing movement cylinder 13 and rapid movement cylinder 14 are spatially separated from each other and have their own piston rods. Both the pressing movement cylinders 13 as well as the rapid movement cylinders 14 are synchronous cylinders (with the same area on both sides of the respective piston). Furthermore, the hydraulic drive device 11 comprises a pressing movement pump 15 as well as a rapid movement pump 16.

During a (forward) rapid movement, the rapid movement pump 16 conveys fluid into an in FIG. 1 upper (generally: first) piston chamber of the rapid movement cylinders 14, so that the pistons of the rapid movement cylinders 14 move downwards comparatively quickly (due to a small piston surface) and thus the press crosshead 12 also moves downwards comparatively quickly. During this rapid movement, a switching valve 17 is in an open position. The switching valve 17 is located in a connecting line 18, which connects an upper and a lower piston chamber of the pressing movement cylinder 13. Therefore, if the piston of the pressing movement cylinder 13 moves downwards during the rapid movement (together with the press crosshead) and fluid is displaced in the lower cylinder chamber as a result, the fluid displaced in this way can enter the upper cylinder chamber of the pressing movement cylinder 13 via the (open) switching valve 17. The pressing movement pump 15 is connected in parallel to the switching valve 17 in terms of fluid technology. At least during an initial phase of the rapid movement, no fluid is conveyed from the lower piston chamber into the upper piston chamber of the pressing movement cylinder 13 via the pressing movement pump 15.

The pressing movement pump 15 serves in particular to provide a force (for the actual powder pressing) during the pressing movement that is subsequent to the rapid movement. During the pressing movement, the pressing movement pump 15 conveys at maximum (with a corresponding maximum speed), at least in an initial phase.

Controlling of the hydraulic drive device is done via a control unit 28.

According to an embodiment, the pressing movement pump 15 starts to convey fluid even before the actual pressing movement, namely preferably with a continuously increasing progress of the conveyance rate (or speed). Even before any force is provided by the pressing movement pump (which is required to press the powder), the pressing movement pump conveys fluid with a (continuously) increasing conveyance rate until the point of maximum conveyance rate is reached (at the start of the actual pressing process). The actual pressing movement is initiated by switching over the switching valve 17. Since at this point in time the conveyance rate of the pressing movement pump 15 has already been increased to the maximum conveyance rate (at the start of the pressing movement) and therefore no more fluid flows via the switching valve at this point, a discontinuity by switching over the switching valve can be easily prevented.

FIG. 2 shows an alternative embodiment of a powder press 10. This embodiment preferably corresponds to the embodiment shown in FIG. 1 with regard to the pressing movement cylinder 13, the switching valve 17 as well as the pressing movement pump 15. In contrast to FIG. 1, however, only one rapid movement cylinder 14 is provided here. In addition, a piston rod of the rapid movement cylinder 14 is connected to a piston rod of the pressing movement cylinder 13 (or in particular formed integrally with it). By this, a controlled pressing process can be achieved in a simple manner.

FIG. 3 shows an exemplary pressing cycle, specifically a force path 20, a press crosshead position 21, a rapid movement pump conveyance rate 22 (or rapid movement pump speed) as well as a pressing movement pump conveyance rate 23 (or pressing movement pump speed).

The diagram in FIG. 3 can be divided into four phases (with corresponding sub-phases): a forward rapid movement 24, a pressing movement 25, a transition phase 26 as well as a reverse rapid movement 27.

During the forward rapid movement 24, initially only the rapid movement pump conveys. At the point in time T1, the pressing movement pump also begins with the conveyance of fluid (namely with an increasing conveyance rate). In an end phase of the rapid movement, a pre-pressing can already take place (which is still conceptually assigned to the rapid movement here). During this pre-pressing, powder is already pre-compacted by the force provided by the input cylinder(s). The actual pressing movement then begins at the point in time T2. Furthermore, the switching valve 17 is switched over (or closed) at point in time T2. At this point in time, the conveyance rate of the pressing movement pump has already been increased to a maximum amount, so that at this point in time no more fluid occurs via the (up to this point in time still) open switching valve. At point in time T3, the pressing movement is then finished. As can be seen, the pressing movement pump initially conveys at the maximum conveyance rate (speed). From a certain point in time onward during the pressing movement, the speed of the feed pump then decreases. At point in time T3, the force acting on the powder is at its maximum. The pressing movement 25 is then followed by the transition phase 26, which in turn can be divided (in sequence) into the following phases: Force reduction, loading, uncovering. At point in time T4, the reverse rapid movement then begins, in which fluid is conveyed exclusively via the rapid movement pump.

At this point, it should be pointed out that all the parts described above are claimed to be essential to the invention when viewed individually and in any combination, in particular the details shown in the drawings. Modifications thereof are familiar to the skilled person.

Furthermore, it is pointed out that a scope of protection as broad as possible is sought. In this respect, the invention defined in the claims can also be specified by features that are described with further features (even without these further features necessarily being included). It is explicitly pointed out that round brackets and the term “in particular” are intended to emphasise the optional nature of features in the respective context (which does not mean, conversely, that a feature is to be regarded as mandatory in the corresponding context without such identification).

### REFERENCE SIGNS

T1 point in time
T2 point in time
T3 point in time
T4 point in time
10 powder press
11 hydraulic drive device
12 press crosshead
13 pressing movement cylinder
14 rapid movement cylinder
15 pressing movement pump
16 rapid movement pump
17 switching valve
18 connecting line
20 force path
21 press crosshead position
22 rapid movement pump conveyance rate
23 pressing movement-pump conveyance rate
24 forward rapid movement
25 pressing movement
26 transition phase
27 reverse rapid movement
28 control unit

1. Hydraulic drive device (11) with at least one press cylinder, in particular a press synchronous cylinder, for a hydraulic press, preferably a powder press (10), wherein the hydraulic drive device is configured to guide a cylinder piston of the press cylinder in a rapid movement at increased speed towards a pressed part and to press the pressed part in a pressing movement at low speed,
wherein the drive device comprises a switching valve (17), a controllable, in particular speed-controllable, pressing movement pump (15) for conveying fluid for the pressing movement and a control unit (28) for controlling the pressing movement pump (15), wherein the drive device is configured, to perform the rapid movement when the switching valve (17) is open and to perform the pressing movement when the switching valve (17) is closed, wherein the control unit (28) is configured to control the pressing movement pump (15) in such a way that a conveyance rate of the pressing movement pump (15) is increased already before the closing of the switching valve (17).

2. Hydraulic drive device (11) according to claim 1,
characterised in that
the conveyance rate of the pressing movement pump (15) is increased to at least 50%, preferably to at least 80%, further preferably to at least approximately 100% of a maximum conveyance rate during the pressing movement and/or a conveyance rate present during an initial phase of the pressing movement already before the closing of the switching valve (17).

3. Hydraulic drive device (11) according to claim 1 or 2, characterised in that
the conveyance rate of the pressing movement pump (15) is increased continuously, in particular in the form of a ramp, already before the closing of the switching valve (17).

4. Hydraulic drive device (11) according to one of the preceding claims,
characterised in that
the switching valve (17) and the pressing movement pump (15) are connected in parallel to each other in terms of fluid technology.

5. Hydraulic drive device (11) according to one of the preceding claims, comprising at least one rapid movement cylinder, in particular rapid movement synchronous cylinder, for carrying out the rapid movement, wherein the fluid can be conveyed into a piston chamber of the rapid movement cylinder preferably by at least one rapid movement pump (16).

6. Hydraulic drive device (11) according to one of the preceding claims, in particular according to one of claim 4 or 5,
characterised in that
rapid movement cylinder and press cylinder can be flowed through by separate fluids.

7. Hydraulic drive device (11) according to one of the preceding claims,
characterised in that
different piston rods are assigned to the rapid movement cylinder and the press cylinder.

8. Hydraulic drive device (11) according to one of the preceding claims,
characterised in that
the same piston rod is assigned to the rapid movement cylinder and the press cylinder.

9. Hydraulic press, preferably powder press (10), comprising a hydraulic drive device according to one of the preceding claims.

10. Method for pressing a pressed part, in particular for powder pressing a powder pressed part, preferably using a hydraulic drive device according to one of claims 1 to 8 and/or a press, in particular a powder press (10), according to claim 9,
wherein a cylinder piston of a press cylinder is guided in a rapid movement at increased speed towards a pressed part and the pressed part is pressed in a pressing movement at low speed,
wherein a switching valve (17) is open during the rapid movement and is closed during the pressing movement, wherein a conveyance rate of a pressing movement pump (15) is already increased before the closing of the switching valve (17).
